(19) United States
(12) Patent Application Publication
(10) Pub. No.: US 2024/0154132 A1
(43) Pub. Date: May 9, 2024

(54) MEMBRANE ELECTRODE ASSEMBLY

(71) Applicant: TOYOTA JIDOSHA KABUSHIKI KAISHA, Toyota-shi (JP)

(72) Inventor: Shunsuke TAKAHASHI, Toyota-shi (JP)

(73) Assignee: TOYOTA JIDOSHA KABUSHIKI KAISHA, Toyota-shi (JP)

(21) Appl. No.: 18/484,957

(22) Filed: Oct. 11, 2023

(30) Foreign Application Priority Data
Oct. 13, 2022 (JP) 2022-164954

(51) Int. Cl. H01M 4/86; C08F 24/00; H01M 8/1004

(52) U.S. Cl. CPC H01M 4/8663; C08F 24/00; H01M 8/1004; H01M 2008/1095

(57) ABSTRACT

Provided is a membrane electrode assembly having excellent power generation performance and durability. A membrane electrode assembly includes: a solid polymer electrolyte membrane; an anode catalyst layer disposed on one surface of the solid polymer electrolyte membrane; and a cathode catalyst layer disposed on the other surface of the solid polymer electrolyte membrane. The membrane electrode assembly includes metal ions selected from cerium ions and manganese ions and a host compound capable of forming an inclusion compound with the metal ions. The cathode catalyst layer includes at least an electrode catalyst and a sulfonyl group-containing polymer. The sulfonyl group-containing polymer includes a constituent unit (u1) having a sulfonyl group and a constituent unit (u2) having a ring structure. The constituent unit (u2) having a ring structure is at least one selected from a constituent unit expressed by Formula (u2-1) or a constituent unit expressed by Formula (u2-2).

### CROSS REFERENCE TO RELATED APPLICATIONS

The present application claims priority from Japanese patent application JP 2022-164954 filed on Oct. 13, 2022, the entire content of which is hereby incorporated by reference into this application.

### BACKGROUND

### Technical Field

The present disclosure relates to a membrane electrode assembly.

### Background Art

A solid polymer fuel cell, which is a fuel cell that generates electricity using an electrochemical reaction between a fuel gas and an oxidant gas, has attracted attention. Since the solid polymer fuel cell allows operation at room temperature while its output density is high, the solid polymer fuel cell has been actively studied as a configuration appropriate for automobile application and the like.

The solid polymer fuel cell generally includes a membrane electrode assembly (also referred to as “MEA”). The membrane electrode assembly includes a solid polymer electrolyte membrane as an electrolyte membrane, an anode catalyst layer disposed on one surface of the solid polymer electrolyte membrane, and a cathode catalyst layer disposed on the other surface of the solid polymer electrolyte membrane. The anode catalyst layer functions as a fuel electrode, and the cathode catalyst layer functions as an air electrode. Gas diffusion layers are further disposed to both surfaces of the MEA in some cases, and this configuration is referred to as a membrane electrode gas diffusion layer assembly (also referred to as “MEGA”).

Each electrode includes a catalyst layer, and in the catalyst layer, an electrode reaction is caused by an electrode catalyst included in the catalyst layer. Since a three-phase interface in which three phases of an electrolyte, a catalyst, and a reaction gas coexist is necessary to cause the electrode reaction, the catalyst layer generally includes the catalyst and the electrolyte. The gas diffusion layer is a layer to supply the reaction gas to the catalyst layer and to give and receive electrons, and a porous material having electron conductivity is used for the gas diffusion layer.

Here, in the solid polymer fuel cell, during power generation, hydrogen peroxide (H₂O₂) is generated from water and oxygen, and hydroxyl radicals (·OH) are generated from the hydrogen peroxide in the catalyst layer in some cases. The hydrogen peroxide and the hydroxyl radicals cause deterioration of electrolyte resins, such as ionomer, included in the solid polymer electrolyte membrane and the catalyst layers.

Therefore, there has been proposed a technique to detoxify hydrogen peroxide radicals generated during power generation of a fuel cell by containing a radical quenching agent, such as cerium ions, in an MEA. Detoxification of hydrogen peroxide radicals is, for example, a reaction from hydrogen peroxide radicals to water.

For example, JP 2008-130460 A discloses a solid polymer electrolyte membrane which includes a polymer electrolyte having sulfonate groups, and contains any one of the following (a) to (c): (a) cerium ions and an organic compound (X) capable of forming an inclusion compound with cerium ions; (b) an inclusion compound (Y) including the organic compound (X) including cerium ions; and (c) at least one of cerium ions or the organic compound (X), and the inclusion compound (Y). JP 2008-130460 A discloses that the solid polymer electrolyte membrane of JP 2008-130460 A has excellent resistance to hydrogen peroxide or peroxide radicals. It discloses that the reason is not necessarily clear, but it is estimated as follows. By the electrolyte membrane containing cerium ions and the organic compound (X), at least part of them form the inclusion compound, which interacts with sulfonate groups (—SO₃—), whereby part of the sulfonate groups are ion-exchanged with the inclusion compound (Y) to form a predetermined structure, thus effectively improving resistance of the polymer electrolyte membrane to hydrogen peroxide or peroxide radicals.

For example, in “Enhancement of oxidative stability of PEM fuel cell by introduction of HO radical scavenger in Nafion ionomer” by Vo Dinh Cong Tinh et al. (Journal of Membrane Science 613 (2020) 118517), a membrane electrode assembly (MEA) in which a coordination complex of 18-crown-6 ether/cerium ions (CRE/Ce) is embedded in Nafion ionomer between a catalyst and membrane layers is disclosed. It is disclosed that, while Ce plays a role in trapping HO-radicals, CRE alleviates dissolution of cerium ions from the MEA during cell operation (for example, Abstract).

### SUMMARY

As described above, in JP 2008-130460 A or “Enhancement of oxidative stability of PEM fuel cell by introduction of HO radical scavenger in Nafion ionomer” by Vo Dinh Cong Tinh et al. (Journal of Membrane Science 613 (2020) 118517), a polymer electrolyte membrane or an anode catalyst layer containing cerium ions as a radical quenching agent and 18-crown-6 ether is disclosed.

However, a decrease in performance was recognized when the membrane electrode assembly containing cerium ions and 18-crown-6 ether was used for investigation, proving that there is room for improvement in terms of power generation performance and durability.

Therefore, the present disclosure provides a membrane electrode assembly having excellent power generation performance and durability.

The inventors have intensively studied to solve the above-described problem and found that the reason of the decrease in performance described above is that 18-crown-6 ether contained in the membrane electrode assembly migrates to the cathode catalyst layer, therefore poisoning the cathode catalyst or decreasing proton conductivity in the ionomer of the cathode. The inventors have further advanced the study and discovered that using a sulfonyl group-containing polymer having a specific structure as an ionomer in the cathode catalyst layer allows suppressing a decrease in performance, thus achieving the disclosure.

Exemplary aspects of embodiments are as follows.
(1) A membrane electrode assembly comprising:
   a solid polymer electrolyte membrane;
   an anode catalyst layer disposed on one surface of the solid polymer electrolyte membrane; and
   a cathode catalyst layer disposed on the other surface of the solid polymer electrolyte membrane,
   wherein the membrane electrode assembly comprises metal ions selected from cerium ions and manganese ions and a host compound capable of forming an inclusion compound with the metal ions,
   wherein the cathode catalyst layer comprises at least an electrode catalyst and a sulfonyl group-containing polymer,
   wherein the sulfonyl group-containing polymer comprises a constituent unit (u1) having a sulfonyl group and a constituent unit (u2) having a ring structure, and
   wherein the constituent unit (u2) having a ring structure is at least one selected from a constituent unit expressed by Formula (u2-1) below or a constituent unit expressed by Formula (u2-2) below:

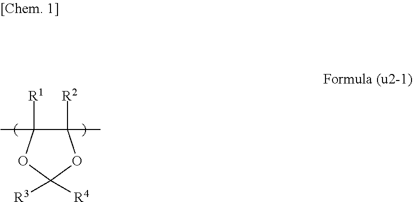

(In the formula, R¹ to R⁴ are each independently a fluorine atom or a perfluoroalkyl group having 1 to 6 carbon atoms),

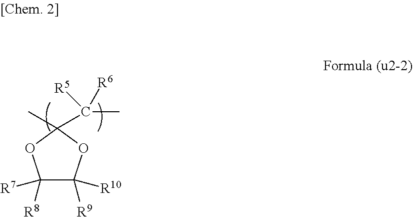

(In the formula, R⁵ to R¹⁰ are each independently a fluorine atom or a perfluoroalkyl group having 1 to 6 carbon atoms).
(2) The membrane electrode assembly according to (1), wherein the constituent unit (u1) having a sulfonyl group is expressed by Formula (u1) below:

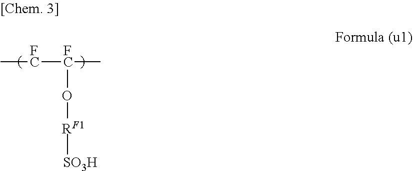

(In the formula, R^{F1} is —(CF₂CF(CF₃)O)ₕ—(CF₂)ᵢ—, h is an integer of 0 or more and 3 or less, and i is an integer of 1 or more and 10 or less).
(3) The membrane electrode assembly according to (1) or (2), wherein the constituent unit (u2) having a ring structure is derived from at least one monomer selected from a monomer expressed by Formula (m2-1) below or a monomer expressed by Formula (m2-2) below:

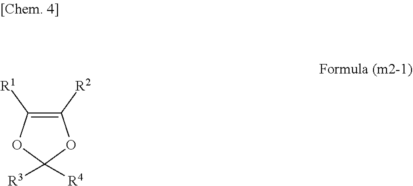

(In the formula, R¹ to R⁴ are each independently a fluorine atom or a perfluoroalkyl group having 1 to 6 carbon atoms.),

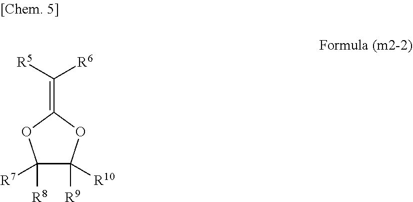

(In the formula, R⁵ to R¹⁰ are each independently a fluorine atom or a perfluoroalkyl group having 1 to 6 carbon atoms.).
(4) The membrane electrode assembly according to any one of (1) to (3), wherein the constituent unit (u1) having a sulfonyl group is derived from a monomer expressed by Formula (m1) below:

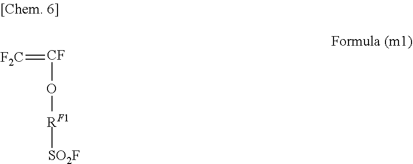

(In the formula, R^{F1} is —(CF₂CF(CF₃)O)ₕ—(CF₂)ᵢ—, h is an integer of 0 or more and 3 or less, and i is an integer of 1 or more and 10 or less.).
(5) The membrane electrode assembly according to any one of (1) to (4), wherein the sulfonyl group-containing polymer further comprises a constituent unit (u3) derived from a tetrafluoroethylene monomer.
(6) The membrane electrode assembly according to any one of (1) to (5), wherein the host compound is a crown ether compound.
(7) The membrane electrode assembly according to (6), wherein the host compound is a crown ether compound having an aromatic ring or aliphatic ring.
(8) The membrane electrode assembly according to any one of (6) or (7), wherein the crown ether compound is at least one compound selected from the group consisting of dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, or dicyclohexano -24-crown-8-ether, and compounds in which an aromatic ring or an aliphatic ring of these compounds is substituted by at least one substituent selected from a halogen atom, a hydroxy group, an amino group, a nitro group, a formyl group, an alkyl group having 1 to 6 carbon atoms, a hydroxyalkyl group having 1 to 6 carbon atoms, a carboxyalkyl group having 2 to 7 carbon atoms, and an aryl group having 6 to 14 carbon atoms.
(9) The membrane electrode assembly according to any one of (1) to (8), wherein the host compound and the metal ions are contained in the anode catalyst layer, the solid polymer electrolyte membrane, or both of the anode catalyst layer and the solid polymer electrolyte membrane.
(10) The membrane electrode assembly according to any one of (1) to (9), wherein the host compound and the metal ions are added to the anode catalyst layer.
(11) The membrane electrode assembly according to any one of (1) to (10), wherein at least part of the host compound and the metal ions form an inclusion compound.
(12) A solid polymer fuel cell comprising the membrane electrode assembly according to any one of (1) to (11).

The present disclosure allows providing the membrane electrode assembly having excellent power generation performance and durability.

### BRIEF DESCRIPTION OF THE DRAWINGS

FIG. 1 is a schematic cross-sectional view for describing an exemplary configuration of a membrane electrode assembly and a solid polymer fuel cell according to the embodiment and cross-sectional view of a main part of an exemplary fuel cell 10.

### DETAILED DESCRIPTION

The embodiment is a membrane electrode assembly that comprises: a solid polymer electrolyte membrane; an anode catalyst layer disposed on one surface of the solid polymer electrolyte membrane; and a cathode catalyst layer disposed on the other surface of the solid polymer electrolyte membrane,
wherein the membrane electrode assembly comprises metal ions selected from cerium ions and manganese ions and a host compound capable of forming an inclusion compound with the metal ions,
wherein the cathode catalyst layer comprises at least an electrode catalyst and a sulfonyl group-containing polymer,
wherein the sulfonyl group-containing polymer comprises a constituent unit (u1) having a sulfonyl group and a constituent unit (u2) having a ring structure, and
wherein the constituent unit (u2) having a ring structure is at least one selected from a constituent unit expressed by Formula (u2-1) below or a constituent unit expressed by Formula (u2-2) below:

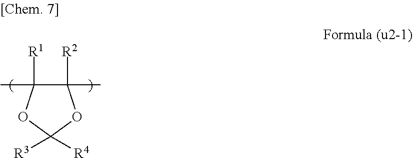

(In the formula, R¹ to R⁴ are each independently a fluorine atom or a perfluoroalkyl group having 1 to 6 carbon atoms),

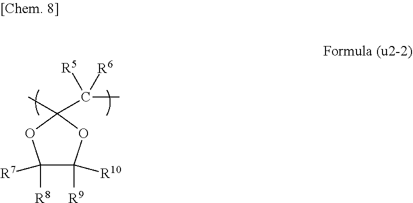

(In the formula, R⁵ to R¹⁰ are each independently a fluorine atom or a perfluoroalkyl group having 1 to 6 carbon atoms).

The embodiment allows providing the membrane electrode assembly having excellent power generation performance and durability. In the embodiment, cerium ions and/or manganese ions that function as a radical quenching agent are added in the membrane electrode assembly (such as the anode catalyst layer or the solid polymer electrolyte membrane). Since hydrogen peroxide radicals can be trapped and detoxified by cerium ions and/or manganese ions, deterioration of the membrane electrode assembly can be suppressed. Additionally, by adding the host compound for the above-described metal ions in the membrane electrode assembly, movement of the above-described metal ions can be suppressed, reducing concentration bias in a planar direction. Moreover, by using the above-described sulfonyl group-containing polymer having high oxygen permeability, which is a highly oxygen-permeable polymer, as an ionomer in the cathode catalyst layer, catalyst poisoning in the cathode catalyst layer in association with migration of the host compound to the cathode catalyst layer and a decrease in performance caused by, for example, a decrease in proton conductivity can be suppressed. Therefore, the membrane electrode assembly according to the embodiment allows having excellent power generation performance as well as excellent durability.

The following describes a configuration of the embodiment.

A solid polymer electrolyte membrane has a function to block distribution of electrons and gases and to move protons (H⁺) generated in an anode from an anode side catalyst layer to a cathode side catalyst layer. As the solid polymer electrolyte membrane in the embodiment, an electrolyte membrane having proton conductivity known in the technical field can be used. As the solid polymer electrolyte membrane, for example, a membrane formed of a fluororesin having sulfonate group as an electrolyte (Nafion (produced by DuPont), FLEMION (produced by AGC), Aciplex (produced by Asahi Kasei Corporation), and the like) can be used.

While the thickness of the solid polymer electrolyte membrane is not particularly limited, it is, for example, 5 μm to 50 μm from the aspect of improvement in proton conductivity.

The cathode catalyst layer functions as an air electrode (oxygen electrode).

The cathode catalyst layer includes at least an electrode catalyst (also simply referred to as “catalyst”) and an electrolyte. In some embodiments, the electrode catalyst is a metal-supported catalyst. In the metal-supported catalyst, a metal catalyst is supported on a carrier.

As the carrier, a carrier known in the technical field can be used and is not particularly limited. Examples of the carrier include, for example, a carbon material, such as carbon black, a carbon nanotube, and a carbon nanofiber; and a carbon compound, such as silicon carbide. For the carrier, one kind may be used alone, or two or more kinds may be used in combination.

The metal catalyst is not particularly limited as long as it exhibits a catalytic action in a reaction at the electrodes.

Air electrode (cathode): O₂+4H⁺+4e⁻→2H₂O

Hydrogen electrode (anode): 2H₂→4H⁺+4e⁻

The metal catalyst is not specifically limited, and, for example, platinum, palladium, rhodium, gold, argentum, osmium, iridium, or an alloy containing two or more of them can be used. Additionally, the platinum alloy is not specifically limited, and, for example, an alloy of platinum and at least one of aluminum, chrome, manganese, iron, cobalt, nickel, gallium, zirconium, molybdenum, ruthenium, rhodium, palladium, vanadium, tungsten, rhenium, osmium, iridium, titanium, or lead can be used. One metal catalyst may be used alone, or two or more metal catalysts may be used in combination.

While the content of the electrode catalyst in the cathode catalyst layer is not particularly limited, for example, the content is 3 mass % to 40 mass % of the total mass of the catalyst layer.

As the electrolyte used in the cathode catalyst layer, the above-described highly oxygen-permeable sulfonyl group-containing polymer is used. By using the highly oxygen-permeable sulfonyl group-containing polymer, deterioration of the cathode catalyst layer in association with migration of the host compound to the cathode catalyst layer can be suppressed. In the embodiment, since the constituent unit (u2) having a ring structure has a cyclic structure, free volume of high molecules increases, and oxygen permeability improves. Although it is a presumption, reasons for allowing suppression of deterioration of the cathode catalyst layer in association with migration of the host compound to the cathode catalyst layer by using the ionomer having high oxygen permeability include that the cyclic structure included in the ionomer, which has hydrophobicity, suppresses the host compound flowing into the cathode catalyst layer. Note that the embodiment is not limited by the presumption.

The constituent unit (u2) having a ring structure can be derived from at least one monomer selected from a monomer expressed by Formula (m2-1) below or a monomer expressed by Formula (m2-2) below.

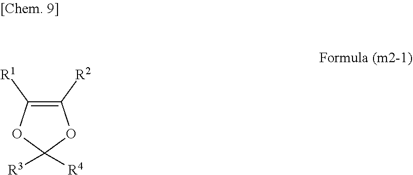

(In the formula, R¹ to R⁴ are each independently a fluorine atom or a perfluoroalkyl group having 1 to 6 carbon atoms.)

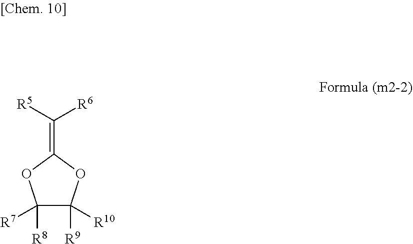

(In the formula, R⁵ to R¹⁰ are each independently a fluorine atom or a perfluoroalkyl group having 1 to 6 carbon atoms.)

From the aspect of oxygen permeability, examples of the monomer expressed by Formula (m2-1) may include monomers below.

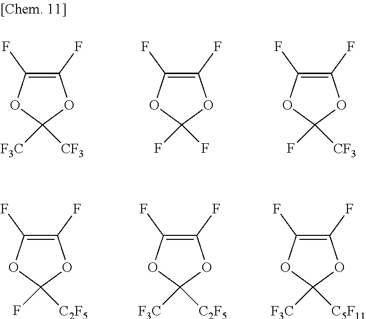

From the aspect of oxygen permeability, examples of the monomer expressed by Formula (m2-2) may include monomers below.

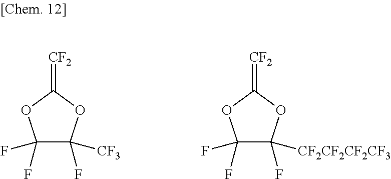

From the aspect of high oxygen permeability, the constituent unit (u1) having a sulfonyl group may be expressed by Formula (u1).

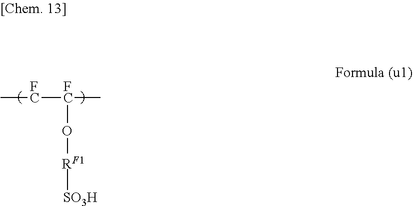

(In the formula, R^{F1} is —(CF₂CF(CF₃)O)ₕ—(CF₂)ᵢ—, h is an integer of 0 or more and 3 or less, and i is an integer of 1 or more and 10 or less.)

For “—(CF₂CF(CF₃)O)ₕ—(CF₂)ᵢ—” of R^{F1}, “—” at the left end indicates a bond to an oxygen atom, and “—” at the right end indicates a bond to a sulfur atom of “SO₃H” in some embodiments.

The constituent unit (u1) having a sulfonyl group can be derived from a monomer expressed by Formula (m1) below. The —SO₂F group in the monomer expressed by Formula (m1) below can be converted into sulfonate group (—SO₃H group) after a polymerization reaction.

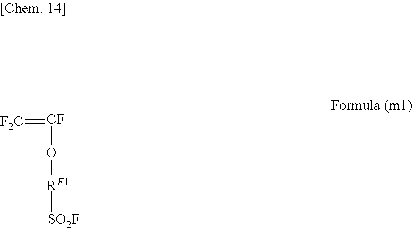

(In the formula, R^{F1} is —(CF₂CF(CF₃)O)ₕ—(CF₂)ᵢ—, h is an integer of 0 or more and 3 or less, and i is an integer of 1 or more and 10 or less.)

For “—(CF₂CF(CF₃)O)ₕ—(CF₂)ᵢ—” of R^{F1}, “—” at the left end indicates a bond to an oxygen atom, and “—” at the right end indicates a bond to a sulfur atom of “SO₃H” in some embodiments. R^{F1} is, for example, a perfluoroalkyl group having 1 to 10 carbon atoms.

Examples of the polymerization method include a known radical polymerization method, such as a bulk polymerization method, a solution polymerization method, a suspension polymerization method, and an emulsion polymerization method. In addition, the polymerization may be performed in liquid or supercritical carbon dioxide. The polymerization is performed under a condition where radicals are generated. Examples of a method of generating radicals include, for example, a method of irradiating with radioactive rays, such as ultraviolet rays, γ rays, and electron rays, and a method of adding a radical initiator. The polymerization temperature is usually 10° C. to 150° C., and 15° C. to 100° C. in some embodiments.

Examples of a method of converting the —SO₂F group into the sulfonate group (—SO₃H group) include a method in which the —SO₂F group in the polymer is hydrolyzed to form sulfonate, and the sulfonate is converted into an acid form to be the sulfonate group. The hydrolysis is performed by, for example, bringing the polymer into contact with a basic compound in a solvent. Examples of the basic compound include, for example, sodium hydroxide and potassium hydroxide. Examples of the solvent include, for example, water or a mixed solvent of water and a polar solvent. Examples of the polar solvent include, for example, alcohols (such as methanol and ethanol) and dimethylsulfoxide.

The sulfonyl group-containing polymer may further include a constituent unit (u3) derived from a tetrafluoroethylene monomer.

The membrane electrode assembly according to the embodiment includes metal ions selected from cerium ions and manganese ions and a host compound capable of forming an inclusion compound with the metal ions. Since cerium ions and/or manganese ions function as a radical quenching agent and can trap and detoxify hydrogen peroxide radicals, deterioration of the membrane electrode assembly can be suppressed. Additionally, by adding the host compound for the above-described metal ions in the membrane electrode assembly, movement of the above-described metal ions can be suppressed, reducing concentration bias in a planar direction.

The metal ions are selected from cerium ions and manganese ions. The cerium ions and the manganese ions function as a radical quenching agent. The radical quenching agent can facilitate conversion of hydroxyl radicals generated from hydrogen peroxide into hydroxide ions, suppressing deterioration of the anode catalyst layer. For example, the reaction of the hydroxyl radicals to the hydroxide ions by the cerium ions is as follows.

Ce³⁺+·OH (hydroxyl radicals)→Ce⁴⁺+OH⁻ (hydroxide ions)

The cerium ions may be positive trivalent ions or may be positive quadrivalent ions. The manganese ions may be positive trivalent ions or may be positive quadrivalent ions.

While a cerium salt for obtaining the cerium ions is not particularly limited, examples of the cerium salt include, for example, cerium nitrate, cerium carbonate, cerium acetate, cerium chloride, ceric sulfate, diammonium cerium nitrate, or tetraammonium cerium sulfate. For the cerium salt, one kind may be used alone, or two or more kinds may be used in combination. The cerium salt may be an organometallic complex salt. Examples of the organometallic complex salt include, for example, cerium acetylacetonate.

While a manganese salt for obtaining the manganese ions is not particularly limited, examples of the manganese salt include, for example, manganese nitrate, manganese carbonate, manganese acetate, manganese chloride, or manganese sulfate. For the manganese salt, one kind may be used alone, or two or more kinds may be used in combination.

The host compound in the embodiment forms an inclusion compound with the cerium ions or manganese ions as a guest compound. The inclusion compound means an addition compound having a configuration in which the above-described metal ions as a guest compound are included in the host compound. Examples of the host compound forming the inclusion compound include, for example, a crown ether compound, a cyclodextrin compound, or a cyclophane compound. For the host compound, one kind may be used alone, or two or more kinds may be used in combination.

The host compound is not particularly limited as long as it is a compound capable of forming the inclusion compound with the above-described metal ions. In some embodiments, the host compound has a cyclic structure. Additionally, in some embodiments, the number of ring members of the cyclic structure is 15 or more, and may be 18 or more. In one embodiment, the host compound may be a crown ether compound. The crown ether compound is a compound having a ring including a repeating structure of (—CH₂—CH₂—Y—) units or (—CH₂—CH₂—CH₂—Y—) units, and Y is at least one hetero atom selected from O, S, N, or P. The crown ether compound traps the metal ions in the ring structure to form the inclusion compound. In some embodiments, the number of ring members of the crown ether compound is 15 or more, and may be 18 or more.

Examples of the crown ether compound include, for example, crown ether or a crown ether derivative. Examples of the crown ether include, for example, 15-crown-5 ether, 18-crown-6 ether, 21-crown-7 ether, and 24-crown-8 ether. In the embodiment, the host compound may be a crown ether compound having an aromatic ring or aliphatic ring. Since the crown ether compound having an aromatic ring or aliphatic ring has high hydrophobicity due to structure thereof, migration to the cathode catalyst layer is little. Examples of the crown ether compound having the aromatic ring or the aliphatic ring include dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, or dicyclohexano-24-crown-8-ether, and compounds in which an aromatic ring or an aliphatic ring of these compounds is substituted by at least one substituent selected from halogen atom (such as a fluorine atom or a bromine atom), hydroxy group, amino group, nitro group, formyl group, alkyl group having 1 to 6 carbon atoms (for example, a methyl group, an ethyl group, a propyl group, and a butyl group), hydroxyalkyl group having 1 to 6 carbon atoms, carboxyalkyl group having 2 to 7 carbon atoms, and aryl group having 6 to 14 carbon atoms (for example, a phenyl group). The number of substituents is, for example, from 1 to 6, from 1 to 5, from 1 to 4, from 1 to 3, 1 or 2, or 1. One of the compounds may be used alone, or two or more the compounds may be used in combination.

In the membrane electrode assembly of the embodiment, at least part of the host compound and the metal ions form an inclusion compound.

The host compound and the metal ions can be contained in the anode catalyst layer, the solid polymer electrolyte membrane, or both of them.

The anode catalyst layer functions as a fuel electrode, that is, a hydrogen electrode.

When the anode catalyst layer contains the host compound and the metal ions, the anode catalyst layer contains at least an electrode catalyst, an electrolyte, metal ions selected from cerium ions and manganese ions, and a host compound capable of forming an inclusion compound with the metal ions. The above-described metal ions can facilitate conversion of hydroxyl radicals generated from hydrogen peroxide into hydroxide ions, suppressing deterioration of the anode catalyst layer.

While the electrode catalyst is not particularly limited, for example, the above-described materials can be used.

The electrolyte used for the anode catalyst layer is an ionomer in some embodiments. The ionomer is also referred to as cation-exchange resin, and is present as a cluster formed of ionomer molecules. The ionomer is not specifically limited, and, for example, the ionomer known in the technical field can be used. Examples of the ionomer include: fluororesin-based electrolyte, such as perfluorosulfonic acid resin; sulfonated plastic-based electrolyte, such as sulfonated polyether ketone, sulfonated polyethersulfone, sulfonated polyether ether sulfone, sulfonated polysulfone, sulfonated polysulfide, and sulfonated polyphenylene; and sulfoalkylated plastic-based electrolyte, such as sulfoalkylated polyether ether ketone, sulfoalkylated polyethersulfone, sulfoalkylated polyetherethersulfone, sulfoalkylated polysulfone, sulfoalkylated polysulfide, and sulfoalkylated polyphenylene. One electrolyte may be used alone, or two or more electrolytes may be used in combination.

In some embodiments, the content of the above-described metal ions and the host compound in the anode catalyst layer is 0.1 mass % to 20 mass % of the total amount of the solid content of the anode catalyst layer. Regarding the content, the inclusion compound is regarded as a mixture of the metal ions and the host compound. That is, when the above-described metal ions and the host compound are added in the anode catalyst layer separately or simply in a mixed manner, only the total amount of the compound metal ions and host compound is subject to calculation, without considering the amount of an inclusion compound generated in the polymer electrolyte even if it is generated. Additionally, when an inclusion compound is formed in advance, and then the inclusion compound is added in the anode catalyst layer, the amount of the inclusion compound is the total amount of the metal ions and the host compound forming the inclusion compound. Furthermore, when metal ions and a host compound, which do not form an inclusion compound, further exist other than the metal ions and the host compound that form an inclusion compound, they are also subject to calculation.

For the relative ratio of the host compound to the above-described metal ions in the embodiment, the mole ratio of the host compound to the above-described metal ions ([number of moles of host compound]/[number of moles of metal ions]) is, for example, 0.1 to 10, is 0.2 to 7.5 in some embodiments, and may be 0.4 to 5.0. That is, the content of the host compound with respect to 1 mole of the above-described metal ions is, for example, 0.1 moles to 10 moles, is 0.2 moles to 7.5 moles in some embodiments, and may be 0.4 moles to 5.0 moles. Similarly to the above, the inclusion compound is regarded as a mixture of both of them also in the relative ratio.

When the solid polymer electrolyte membrane contains the host compound and the metal ions, the solid polymer electrolyte membrane that contains the host compound and the metal ions can be obtained by, for example, the following methods.
(1) After a solid polymer electrolyte membrane is immersed in a solution containing metal ions to exchange ions of groups, such as sulfonate groups, with the metal ions, the solid polymer electrolyte membrane is immersed in a solution containing a host compound so that the host compound is included in the membrane.
(2) A method of producing a membrane by coating using a liquid obtained as follows. After a compound containing metal ions (such as cerium salt) is added in a dispersion liquid of polymer electrolytes to exchange ions of groups, such as sulfonate groups, with the metal ions, a solution or solid containing a host compound is added to the dispersion liquid to obtain the liquid.
(3) A method in which a compound containing metal ions (such as cerium salt) and a host compound are caused to react in a solvent to form an inclusion compound, and next, a solid polymer electrolyte membrane is immersed in a solution in which the inclusion compound is dissolved to exchange ions of groups, such as sulfonate groups, with the inclusion compound so that the inclusion compound is included in the membrane.
(4) A compound containing metal ions (such as cerium salt) and a host compound are caused to react in a solvent to form an inclusion compound. Next, the inclusion compound or its solution is added in a dispersion liquid of polymer electrolytes to obtain a liquid. A membrane is produced by coating using the obtained liquid.

### [Method for Manufacturing Membrane Electrode Assembly]

A catalyst layer can be formed by, for example, a process of preparing a catalyst ink (for example, a solid content concentration of about 10%) including an electrode catalyst, an ionomer, and a solvent, a process of applying the catalyst ink over a substrate surface and volatilizing the solvent in the coating film to form a catalyst layer on the substrate surface, and a process of transferring the catalyst layer on the substrate surface to an electrolyte membrane. In addition, a catalyst layer can be formed by a method of directly applying the catalyst ink over a solid polymer electrolyte membrane instead of the substrate. By forming a cathode catalyst layer and an anode catalyst layer on the solid polymer electrolyte membrane, a membrane electrode assembly can be produced.

Examples of a method for applying the catalyst ink include, for example, a spray method, a blade coating method using a doctor blade or applicator, a die coating method, a reverse roll coater method, and an intermittent die coating method.

For the anode catalyst layer, the above-described metal ions and the above-described host compound may be contained in a catalyst ink for forming the anode catalyst layer. Specifically, the catalyst ink for forming the anode catalyst layer can include an electrode catalyst, an ionomer (for example, an ionomer having sulfonate groups), the above-described metal ions, the host compound, and a solvent. The above-described metal ions and the host compound may be each added separately or may be added in a form of a complex of both.

### [Specific Configurations of Membrane Electrode Assembly and Solid Polymer Fuel Cell]

The basic unit of a solid polymer fuel cell is a membrane electrode assembly (MEA) in which catalyst layers (electrodes) are assembled to both surfaces of a solid polymer electrolyte membrane. In the solid polymer fuel cell, gas diffusion layers are generally disposed on external sides of the catalyst layers. The gas diffusion layers are for supplying a reaction gas and electrons to the catalyst layers, and carbon paper, carbon cloth, and the like are used. The catalyst layers are portions that become reaction fields of an electrode reaction.

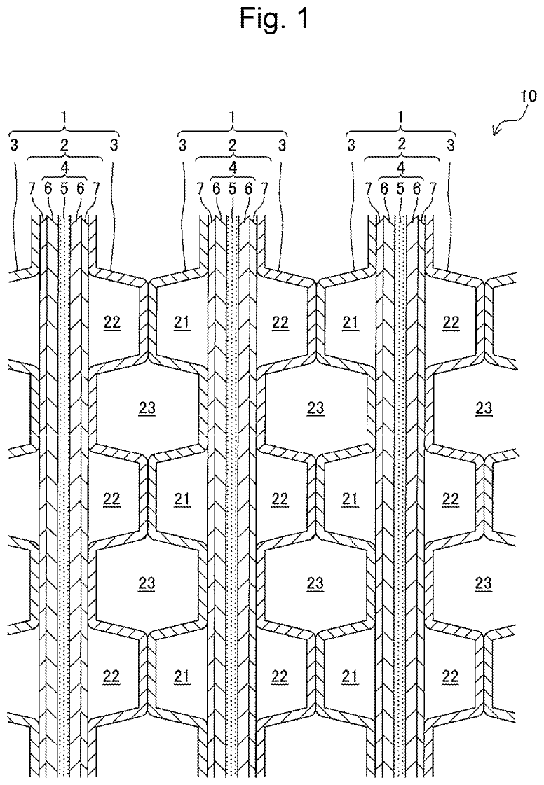

The following describes the configurations of the membrane electrode assembly and the solid polymer fuel cell with reference to FIG. 1. FIG. 1 is a schematic cross-sectional view for describing an exemplary configuration of the solid polymer fuel cell according to the embodiment and cross-sectional view of a main part of an exemplary fuel cell 10. The solid polymer fuel cell includes a stacked body of unit cells constituted of an electricity generating body and fuel cell separators disposed on both surfaces of the electricity generating body. The plurality of unit cells are stacked in a stacking direction, and the respective unit cells are electrically connected in series. As illustrated in FIG. 1, in the fuel cell 10, a plurality of unit cells 1 as a basic unit are stacked. Each unit cell 1 is a solid polymer fuel cell that generates an electromotive force by an electrochemical reaction between an oxidant gas (such as air) and a fuel gas (such as hydrogen). The unit cell 1 includes a membrane electrode gas diffusion layer assembly (MEGA) 2 and separators 3 in contact with the MEGA 2 so as to partition the MEGA 2. On both sides of the MEGA 2, gas diffusion layers (GDL) 7 are disposed. In the embodiment, the MEGA 2 are sandwiched by a pair of separators 3, 3.

The MEGA 2 includes a membrane electrode assembly (MEA) 4 and gas diffusion layers 7, 7 disposed on both surfaces of the membrane electrode assembly 4. The membrane electrode assembly 4 is constituted of an electrolyte membrane 5 and a pair of electrodes 6, 6 assembled to sandwich the electrolyte membrane 5. The electrolyte membrane 5 is, for example, a proton-conductive ion exchange membrane formed of a solid polymer material. The electrode 6 includes, for example, a porous carbon material supporting a catalyst, such as platinum. The electrode 6 disposed on one side of the electrolyte membrane 5 functions as an anode, and the electrode 6 on the other side functions as a cathode. The gas diffusion layer 7 is formed of a conductive member having gas permeability. Examples of the conductive member having gas permeability include, for example, a carbon porous body, such as carbon paper or carbon cloth, or a metal porous body, such as metal mesh or foam metal. In the embodiment, the anode electrode is constituted of an anode catalyst layer, and the cathode electrode is constituted of a cathode catalyst layer.

The MEGA 2 is a power generation unit of the fuel cell 10. The separator 3 is in contact with the gas diffusion layers 7 of the MEGA 2. When the gas diffusion layer 7 does not exist, the membrane electrode assembly 4 serves as the power generation unit. In this case, the separator 3 is in contact with the membrane electrode assembly 4. Accordingly, the power generation unit of the fuel cell 10 includes the membrane electrode assembly 4 and is in contact with the separator 3.

The separator 3 is a plate-shaped member having a metal substrate (such as a stainless steel substrate). The metal substrate is excellent in conductivity, gas impermeability, and the like. In FIG. 1, a surface on the power generation unit side of the separator 3 abuts on the gas diffusion layer 7 of the MEGA 2, and the other surface abuts on another adjacent separator 3.

A gas flow channel 21 defined between the gas diffusion layer 7 on one electrode (that is, the anode electrode) 6 side and the separator 3 is a channel through which a fuel gas flows. A gas flow channel 22 defined between the gas diffusion layer 7 on the other electrode (that is, the cathode electrode) 6 side and the separator 3 is a channel through which an oxidant gas flows. When the fuel gas is supplied to the one gas flow channel 21 opposed via the cell 1, and the oxidant gas is supplied to the gas flow channel 22, an electrochemical reaction occurs inside the cell 1 to generate an electromotive force.

Furthermore, one cell 1 and another cell 1 adjacent thereto are disposed such that the anode electrode 6 and the cathode electrode 6 face one another. The top on the back surface side of the separator 3 disposed along the anode electrode 6 of the one cell 1 is in surface contact with the top on the back surface side of the separator 3 disposed along the cathode electrode 6 of the other cell 1. A coolant (such as water) to cool the cells 1 flows through a space (cooling agent channel) 23 defined between the separators 3, 3 that are in surface contact between the adjacent two cells 1.

### EXAMPLES

The following describes the embodiment using examples.

### Example 1

### (Synthesis Method)

Perfluoro 2-ethyl-1,3-dioxole (PED) (5.07 g) and perfluoro-sulfonyl fluoride vinyl ether (PSVE-A) (28.79 g) were mixed, and 0.05 mol % of an initiator was added thereto. Freeze-deaeration and nitrogen substitution were repeated thereon three times, and left to react at room temperature for two days. Afterwards, unreacted components were removed by heating unreacted monomers under a vacuum at a temperature of 120° C. for one hour to obtain an intended fluorosulfonyl group-containing polymer (7.0 g). The equivalent mass of the fluorosulfonyl group-containing polymer was 810 g/mol. —SO₂F groups of the fluorosulfonyl group-containing polymer were converted into sulfonate groups (—SO₃H groups) to obtain an intended sulfonyl group-containing polymer. The sulfonyl group-containing polymer functions as a highly oxygen-permeable ionomer.

### (Equivalent Mass of Fluorine-containing Polymer (H))

1.0 g of the fluorosulfonyl group-containing polymer and 10 mL of water/methanol mixed solution containing sodium hydroxide at a concentration of 0.35 N were added into a container made of polycarbonate and allowed to stand at 60° C. for 40 hours, thereby converting the —SO₂F groups of the fluorosulfonyl group-containing polymer into —SO₃Na groups. The solution was subjected to back titration with 0.1 N of hydrochloric acid using a phenolphthalein as an indicator to obtain the amount of sodium hydroxide in the solution. Accordingly, the equivalent mass of a —SO₃H type polymer of fluorine-containing polymer (H) was calculated. The equivalent mass at this time is considered the equivalent mass of the polymer in some cases.

### (Formation of Cathode Catalyst Layer)

A metal-supported catalyst as an electrode catalyst was dispersed in an ionomer solution with the above-described sulfonyl group-containing polymer dispersed in water and ethanol using a bead mill to prepare a catalyst ink. The mass ratio of water to ethanol (water/ethanol) in the catalyst ink was about 1. The obtained catalyst ink was coated over a polytetrafluoroethylene sheet and dried to form a cathode catalyst layer.

The Pt weight per unit area in the cathode catalyst layer was 0.2 mg/cm², and the mass ratio of ionomer to carbon (I/C) was 1.0. As catalyst particles, 30% Pt/Vulcan (registered trademark) (produced by Tanaka Kikinzoku Kogyo, TEC10V30E) was used.

### (Formation of Inclusion Compound (Complex))

18-crown-6 ether (18CRE) (2.64 g, 0.01 mol) and cerium nitrate(III) 6-hydrate (4.34 g, 0.01 mol) were weighed and taken into a 100 mL eggplant flask and stirred at room temperature for 24 hours with ethanol (20 mL) and water (20 mL) added. Then, after the solution was removed with an evaporator, vacuum drying was performed under 60° C. for one hour to obtain a white solid. By confirming that the peak derived from ether groups shifted to a low wavenumber side by FT-IR, it was confirmed that CRE and Ce formed an inclusion compound.

### (Formation of Anode Catalyst Layer)

As an electrode catalyst, 60 wt % Pt/Ketjen (registered trademark) was used. The electrode catalyst and the above-described complex were dispersed in an ionomer solution (DE2020) including water, ethanol, and Nafion (registered trademark) to prepare a catalyst ink. The catalyst ink was coated over a polytetrafluoroethylene sheet and dried to form an anode catalyst layer.

The Pt weight per unit area in the anode catalyst layer was 0.1 mg/cm², and the cerium ion concentration was 4 μg/cm². As described above, a host compound was contained in a ratio of Ce:ligand=1:1 mol. The mass ratio of ionomer to carbon (I/C) was 1.0.

### (Production of Membrane Electrode Assembly)

The obtained cathode catalyst layer and anode catalyst layer were heat-transferred to both respective surfaces of a Nafion (registered trademark) membrane (NR211) to produce a membrane electrode assembly E1. The heat transfer conditions were set to 140° C., 50 kgf/cm² (4.90 MPa), and 5 min. The electrode area of the membrane electrode assembly for initial performance test was 1 cm×1 cm (1 cm²). The electrode area of the membrane electrode assembly for durability test was 3.6 cm×3.6 cm (12.96 cm²). The membrane electrode assembly was sandwiched by paper diffusion layers (GDL) with water-repellent layers to produce a test cell.

### Comparative Example 1

A membrane electrode assembly C1 was produced similarly to Example 1 except that an anode catalyst layer was formed without adding a host compound and a cathode catalyst layer was formed using Aquivion (D79-25BS) as an ionomer solution. The equivalent mass of Aquivion was 790 g/mol.

### Comparative Example 2

A membrane electrode assembly C2 was produced similarly to Example 1 except that a cathode catalyst layer was formed using Aquivion (D79-25BS) as an ionomer solution.

### Comparative Example 3

A membrane electrode assembly C3 was produced similarly to Example 1 except that an anode catalyst layer was formed without adding a host compound.

### Example 2

A membrane electrode assembly E2 was produced similarly to Example 1 except that benzo-18-crown-6 ether (B18CRE) (0.01 mol) was used instead of 18CRE (0.01 mol).

### Comparative Example 4

A membrane electrode assembly C4 was produced similarly to Example 2 except that a cathode catalyst layer was formed using Aquivion (D79-25BS) as an ionomer solution.

### Evaluation

### (Initial Performance Test)

The current-voltage characteristics of the above-described test cells (electrode area: 1 cm²) were evaluated under the following conditions. As the result, voltage values at 1.0 A/cm² were shown in Table 1 below. Low-humidify environment (30% RH), sweep rate: 20 mA/s, cell temperature: 90° C., pressure: 150 kPa (abs), cathode gas type: air, cathode gas flow rate: 2.0 L/min, anode gas type: hydrogen, anode gas flow rate: 0.5 L/min.

### (Durability Test)

The above-described test cells (electrode area: 12.96 cm²) were incorporated in a cell for power generation to conduct the durability test under a high-humidify environment (90° C., 30% RH). In the durability test, the initial characteristics of the solid polymer fuel cell and the characteristics after the durability test load were evaluated at a cell temperature of 90° C., with hydrogen/air supplied, and at a current density of 0.05 A/cm². Hydrogen and air were each humidified so as to have a dew point of 67° C. on the anode side and a dew point of 67° C. on the cathode side and supplied into a cell, and the cell voltage at the beginning of operation and the relationship between an elapsed time after starting the operation and the cell voltage were measured. The results were shown in Table 1 below. Under the above-described cell evaluation conditions, the cell voltage at the beginning of the operation and the cell voltage after a lapse of 300 hours after starting the operation were measured.

TABLE 1

| | | | | Initial | Durability test | | |
|---|---|---|---|---|---|---|---|
| | Anode catalyst | | | performance | | Voltage at | |
| | layer | | Cathode catalyst | test | Voltage at | 0.05 A/cm² (V) | |
| | Host | Cerium | layer | Voltage at | 0.05 A/cm² (V) | (after a lapse | Change |
| | compound | nitrate | Ionomer | 1.0 A/cm² (V) | (beginning) | of 300 hours) | rate (%) |
| Example 1 | 18CRE | Added | Highly oxygen- | 0.68 | 0.86 | 0.82 | 95 |
| | | | permeable | | | | |
| Comparative | — | Added | Aquivion | 0.68 | 0.86 | 0.65 | 76 |
| Example 1 | | | | | | | |
| Comparative | 18CRE | Added | Aquivion | 0.48 | 0.82 | 0.75 | 91 |
| Example 2 | | | | | | | |
| Comparative | — | Added | Highly oxygen- | 0.73 | 0.87 | 0.68 | 78 |
| Example 3 | | | permeable | | | | |
| Example 2 | B18CRE | Added | Highly oxygen- | 0.71 | 0.87 | 0.83 | 95 |
| | | | permeable | | | | |
| Comparative | B18CRE | Added | Aquivion | 0.62 | 0.83 | 0.78 | 94 |
| Example 4 | | | | | | | |

### Discussion

In a comparison of Example 1 and Comparative Example 2 having an anode catalyst layer with a host compound and cerium ions added, Example 1, in which the highly oxygen-permeable ionomer was used, exhibited excellent power generation performance in the initial performance test and had a small decrease in performance after a lapse of 300 hours in the durability test.

Upper limit values and/or lower limit values of respective numerical ranges described in this specification can be appropriately combined to specify an appropriate range. For example, upper limit values and lower limit values of the numerical ranges can be appropriately combined to specify an appropriate range, upper limit values of the numerical ranges can be appropriately combined to specify an appropriate range, and lower limit values of the numerical ranges can be appropriately combined to specify an appropriate range.

While the embodiment has been described in detail, the specific configuration is not limited to the embodiment. Design changes within a scope not departing from the gist of the disclosure are included in the present disclosure.

### DESCRIPTION OF SYMBOLS

1 Cell
2 MEGA (Power generation unit)
3 Separators (Fuel cell separator)
4 Membrane electrode assembly (MEA)
6 Electrode
7 Gas diffusion layer
10 Fuel cell
21, 22 Gas flow channel

What is claimed is:

1. A membrane electrode assembly comprising:
a solid polymer electrolyte membrane;
an anode catalyst layer disposed on one surface of the solid polymer electrolyte membrane; and
a cathode catalyst layer disposed on the other surface of the solid polymer electrolyte membrane,
wherein the membrane electrode assembly comprises metal ions selected from cerium ions and manganese ions and a host compound capable of forming an inclusion compound with the metal ions,
wherein the cathode catalyst layer comprises at least an electrode catalyst and a sulfonyl group-containing polymer,
wherein the sulfonyl group-containing polymer comprises a constituent unit (u1) having a sulfonyl group and a constituent unit (u2) having a ring structure, and
wherein the constituent unit (u2) having a ring structure is at least one selected from a constituent unit expressed by Formula (u2-1) below or a constituent unit expressed by Formula (u2-2) below: 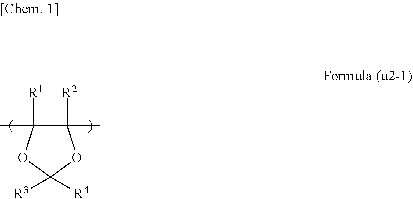
(In the formula, R¹ to R⁴ are each independently a fluorine atom or a perfluoroalkyl group having 1 to 6 carbon atoms), 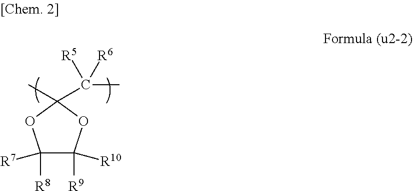
(In the formula, R⁵ to R¹⁰ are each independently a fluorine atom or a perfluoroalkyl group having 1 to 6 carbon atoms).

2. The membrane electrode assembly according to claim 1,
wherein the constituent unit (u1) having a sulfonyl group is expressed by Formula (u1) below: 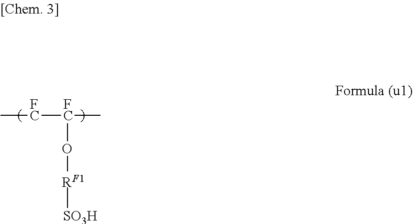
(In the formula, R^{F1} is —(CF₂CF(CF₃)O)ₕ—(CF₂)ᵢ—, h is an integer of 0 or more and 3 or less, and i is an integer of 1 or more and 10 or less).

3. The membrane electrode assembly according to claim 1,
wherein the host compound is a crown ether compound.

4. The membrane electrode assembly according to claim 3,
wherein the crown ether compound is at least one compound selected from the group consisting of dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, or dicyclohexano-24-crown-8-ether, and compounds in which an aromatic ring or an aliphatic ring of these compounds is substituted by at least one substituent selected from a halogen atom, a hydroxy group, an amino group, a nitro group, a formyl group, an alkyl group having 1 to 6 carbon atoms, a hydroxyalkyl group having 1 to 6 carbon atoms, a carboxyalkyl group having 2 to 7 carbon atoms, and an aryl group having 6 to 14 carbon atoms.

5. The membrane electrode assembly according to claim 1,
wherein the host compound and the metal ions are contained in the anode catalyst layer, the solid polymer electrolyte membrane, or both of the anode catalyst layer and the solid polymer electrolyte membrane.
